(19) United States
(12) Patent Application Publication
(10) Pub. No.: US 2006/0010047 A1
(43) Pub. Date: Jan. 12, 2006

(54) Sarbanes-Oxley Anonymous Reporting System

(75) Inventor: Erik Minor, West Caldwell, NJ (US)

Correspondence Address: OCULOS INC, 35 BEACHWOOD ROAD, WEST CALDWELL, NJ, 07006, US

(73) Assignee: OCULUS INC, West Caldwell, NJ (US)

(21) Appl. No.: 10/710,373

(22) Filed: Jul. 6, 2004

(51) Int. Cl. G06F 17/00; G06F 7/00

(52) U.S. Cl. 705/30; 707/100

(57) ABSTRACT

This invention relates to information escrow and anonymous reporting systems and methods, but more specifically, to an independent information storage and retrieval system that escrows information anonymously reported under the Sarbanes-Oxley Act. The present invention aims to provide public companies with a system and method to comply with the Sarbanes-Oxley Act. The Act requires public companies to establish procedures for the receipt, retention, and treatment of complaints received by the issuer of securities regarding accounting, internal accounting controls, or auditing matters; and the confidential, anonymous submissions by employees of the issuer of concerns regarding questionable accounting or auditing matters. To achieve this goal, the invention provides a method and a system for implementing the methods that are specifically directed to statutory compliance.

### BACKGROUND OF INVENTION

This invention relates to information escrow and anonymous reporting systems and methods, but more specifically, to an independent information storage and retrieval system that escrows information anonymously reported under the Sarbanes-Oxley Act.

The present invention aims to provide public companies with a system and method to comply with the Sarbanes-Oxley Act. The Act requires public companies to establish procedures for the receipt, retention, and treatment of complaints received by the issuer of securities regarding accounting, internal accounting controls, or auditing matters; and the confidential, anonymous submissions by employees of the issuer of concerns regarding questionable accounting or auditing matters. To achieve this goal, the invention provides a method and a system for implementing the methods that are specifically directed to statutory compliance.

Aspects of the statute relating to receipt, retention and treatment of complaints are met by a secure, tamperproof information escrow system and method that is independent of any network or database of the public company. The secure escrow system is preferably accessed via the Internet, but an independent private network may also be provided. Aspects of the statute relating to anonymity may be met by assigning high-level encrypted passwords to users, i.e. whistle-blowers, comprising alpha, numeric, upper and lower case characters.

U.S. patent application by Ferraro, Pub. No. 2003/0088645, discloses an anonymous reporting system adapted to allow individuals or witnesses to overcome a fear-factor by enabling them to anonymously report incidents or behavior of others that may lead to violent or criminal behavior. The system appears to have been designed for schools or institutions to check violent behavior, and anonymous submission may be received via telephone or the internet. In his disclosure, Ferraro assigns a random ID to the user to enable further submissions. In addition, Ferraro provides a mechanism for new submissions and, to a limited degree, the ability of the anonymous user to observe the results of a previous submission. In addition to the type of information reported, i.e. financial as opposed to threatened or violent activity, other basis of distinguishing the Sarbox system include: (a)The Ferraro system does not ensure anonymity. As described in section 25 of the Ferraro Application “The subscriber then requests that the incidents be reported using the system in, if desired, a fully anonymous manner”. The Sarbox system is structured to only allow secure and anonymous submissions.

(b) The Ferroro system provides a random number to identify the user for subsequent access and retrieval. Number assignment is easily thwarted by hackers especially when there are no additional control processes in place to identify hacking attempts. There is no mention of such hacking prevention measures within the Ferraro system which makes it incapable of satisfying the requirements of the Sarbanes-Oxley Act. The Sarbox system, however, is geared for security in every regard. First, the user may opt not to follow-up on their request. In this instance no password is assigned, hence nothing to hack. If the user does decide to provide feedback or follow-up on the request then a random id comprising of upper and lower case letters, symbols and numbers is assigned and provided to the user only once. If too many failed attempts are made to access this request then the request is automatically locked and notification is sent to the Sarbox system manager to track, put in additional controls to thwart the attack and prosecute the individuals attempting to hack the system. This is but one example why the Sarbox System is more than just a software application, but a complete integrated solution that completely addresses the security and confidentiality requirements of the Sarbanes-Oxley Act. Such hack prevention processes exists everywhere there is a password within the system.

(c) The Ferraro system allows the reporting user to establish accounts. This is inherently insecure and therefore no such account management to track, as Ferraro describes it, “personas” to apparently group requests together exists within the Sarbox system as such grouping could also jeopardize the integrity of the user.

(d) The Ferraro system does not ensure that the user is submitting the request outside of the company's network. It is virtually impossible to guarantee the anonymity of a user if they file a complaint from within a corporate network as “hits” to websites as well as the time in which they were accessed are standard network auditing practices within most companies. As such, for any system and method to meet the requirements of the Sarbanes-Oxley Act it must ensure that a user only accesses the system outside of the company's internal network. The Sarbox system is by design an external application that provides such security checks to ensure that users only access the application from outside of the company's internal network. This is yet another aspect of the present invention that includes the querying the user about the independence of his/her access network, or even further, by comparing the IP address of the user's access terminal with a known list of IP addresses used by the company under which the user is filing a complaint.

(e) In addition, a further aspect of the present invention concerns providing an independent database, separated and apart from the institution's to prevent internal tampering if database information, which is apparently not an objective of Ferraro. Importantly, the present invention (the Sarbox System) is directed to a database adapted to receive reportable events related to accounting practices, internal accounting controls, and auditing of a public company. Specifically, an Audit Committee is provided with a secure, restricted access to the complaint database on a read-only basis to prevent any changes or manipulation of the complaint database contents. In addition, there is also a management action database which tracks how the management acted and timeframes in which this action occurred to address the complaints. This database is also available to the Audit Committee on a read-only basis to allow the audit committee to see and track the timeliness and effectiveness of managements response.

(f) As indicated in section 40 of the Ferraro application users are permitted to edit reports. This violates the retention requirement of the Sarbanes-Oxley Act as each communication made must be maintained in such a manner that no alterations are made to any submissions. The Sarbox system ensures that all entries made are unalterable.

(g) Confidentiality is a key requirement of the requirement of the Sarbanes-Oxley Act. Upon submission, the Ferraro system emails the report to the company representative. This is a violation of the confidentiality requirement. Within the Sarbox system only a notification of the fact that a complaint has been filed is emailed to an Audit Committee member, no information on the complaint is communicated via email as this is an inherently insecure method of communication.

(h) Section 51 of the Ferraro application stipulates that it is an open system and not password protected such that anyone can enter the site and create and submit a report. This functionality is exactly the opposite of that which is required by the Sarbanes-Oxley Act (ACT) and that provided with the Sarbox system. The ACT focuses on key individual submissions, as such the Sarbox system contains a company password process to ensure only those individuals, as defined by the company, have the ability to file submissions. The obvious purpose of such a requirement is to prevent the filing of false claims.

(i) In this same section the Ferraro application details the workings of a “Fuzzy database” matching process which in essence means that delivery of complaints is not guaranteed. This again does not meet the requirements of the Sarbanes-Oxley Act which requires that “each audit committee shall establish the procedures for the receipt . . . of complaints. The Sarbox system is structured that no complaint can be filed until both the exact company name and password are provided, which ensures proper identification of the company, and that a confirmation screen is provided to the user when the complaint has been stored within the system. The Sarbox system processes are such that immediately upon submission the request is stored and a back-up is updated via a secured process (to prevent loss even if a disaster were to occur that would destroy or impair the integrity of the main data storage device).

(j) The Ferraro system has no mechanism for tracking the ultimate resolution of the complaint, another key requirement of the ACT, whereas the Sarbox system provides a separate secure stream to track updates made by management within the company, a management summary page to explain how each complaint was addressed, and a status code (e.g. Open/Pending Investigation, Closed/Controls Fixed etc.) for each complaint. These tracking functions in total enable complete compliance with the ACT which is unique to the Sarbox system.

U.S. Pat. 6,624,650, as well as his pending application (Pub. No. 2001/0056546), describes an information escrow system and method designed to release information upon occurrence of an event, i.e. the passage of time or other occurrence of an event. Stated applications include intestate succession via a will and a whistle-blower's conditional reporting of sensitive information that may or may not have a disclosure need.

U.S. Pat. No. 6,449,621, describes an information escrow system that is used to confidentially store consumer information, such as purchasing habits, credit card use, etc. Pettovello does not, among other things, disclose any audit interface, user input for initial reporting, status tracking or reporting update mechanism.

U.S. Pat. No. 5,895,450 to Sloo discloses an automated complaint handling system for negotiating disputes between vendors and customers upon receipt of defective goods.

U.S. Pat. No. 6,345,288 to Reed et al. has an extensive disclosure directed generally to provider-consumer information handling. Reference is made to FIG. 40 and the discussion beginning at the bottom of column 123 relating to anonymous reporting.

U.S. patent application Pub. No. 2001/0011351 to Sako describes a participation authority management system that allows a user to anonymously participate in a session, such as, in electronic bidding, lotteries, voting etc.

U.S. patent application Pub. No. 2003/0084003 to Pinkas et al. describes a third party information trust system to verify the authenticity of a file transmitted by a sender to a receiver.

### BRIEF DESCRIPTION OF DRAWINGS

FIG. 1 is a high level overview of the parties involved under that whose actions are regulated by the Sarbanes Oxley Act (or other similar regulation or future restatement thereof).

FIG. 2 is an overview of the steps involved to maintain compliance with the Sarbanes-Oxley Act anonymous complaint submission requirements within the Sarbanes-Oxley Anonymous Reporting System, also referred to within this document at the Sarbox system or the SarboxReporter.

### DETAILED DESCRIPTION

The present invention is structured so that all individuals who are in a position to know material facts about the accounting, internal accounting controls or auditing matters of an organization, (i.e. “Key individuals”) have the ability to anonymously report their concerns regarding questionable accounting or auditing matters to the Audit Committee of that same organization. Specifically, the structure of this new invention is to achieve this functionality while simultaneously meeting all of the requirements for reporting such matters as dictated by the Sarbanes-Oxley Act (ACT). While meeting these requirements is an important measure for this application, it is also structured to be easily adapted to address modifications to this, or similar, legislation whose ultimate purpose is to provide an open and safe avenue of communications of accounting or audit issues to the management of organizations.

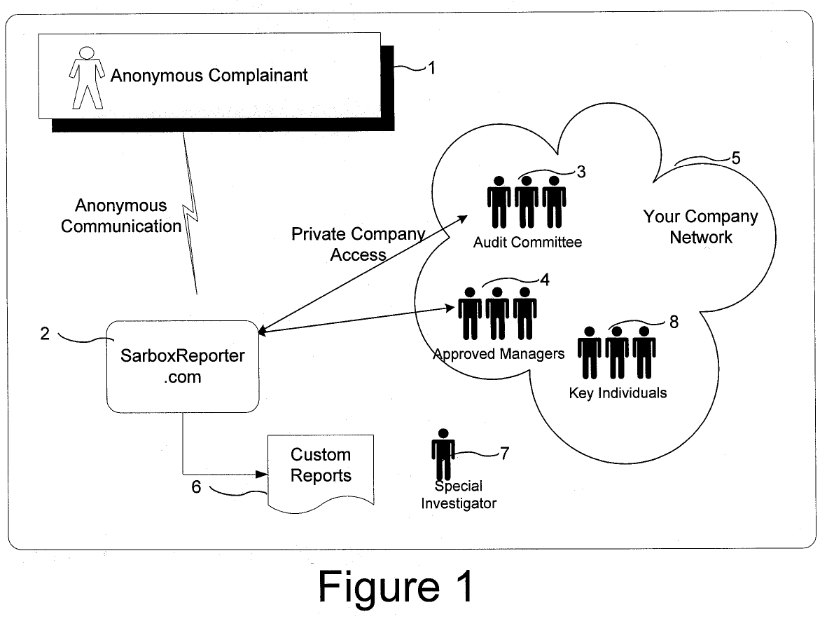

FIG. 1 illustrates the participants involved in this process. The Audit Committee (3) first ensures that every key individual is made aware of their responsibility to forward any and all accounting and audit concerns to their attention. They provide the web address of www.SarboxReporter.com (2) to all of their organization's key individuals—which is comprised of employees (8) and any consultant (8), auditor (8) or other individual (8) who meets the key individual definition above—as well as the company Name and Company Wide Password to be used to file such complaints. This method is implemented to ensure that fraudulent claims are mitigated as only key individuals would have sufficient knowledge to file valid complaints.

The Audit Committee (3) of the company then determines which senior managers or other approved managers (4) within the company will be responsible for reviewing the new complaints and working with the necessary key individuals (8) within the organization to address complaints. They are provided by the Audit Committee (3) a specific Company Level ID, Company Private Password and Individual User ID and Password to access the Sarbox system. The Audit Committee (3) members will also be provided with their own individual Company Level ID/Password and Individual ID/Password to monitor the overall progress of the Approved Managers.

Lastly, the Audit Committee (3) provides the administrator of the Sarbox system (2) a list of IP addresses that will be used within the Security Management Layer (26).

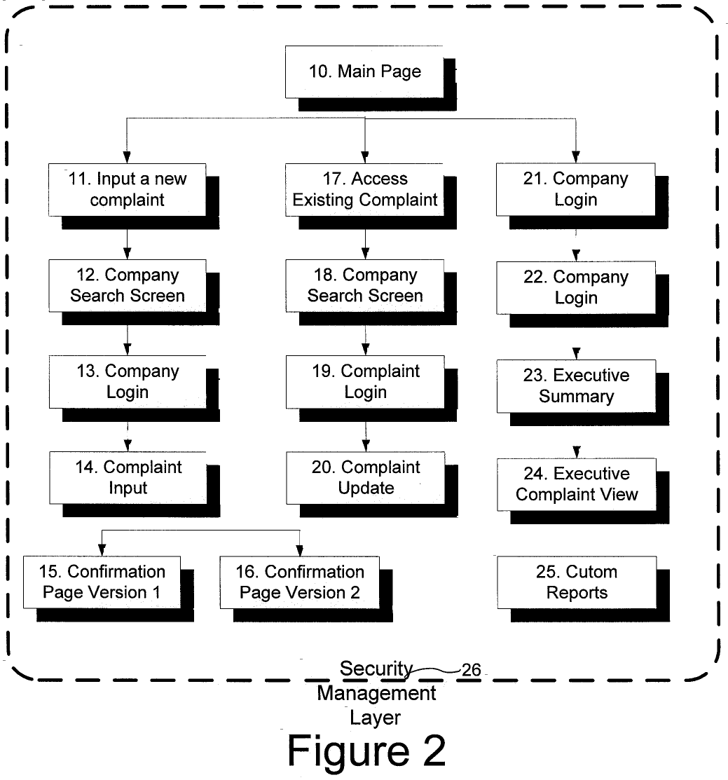

FIG. 2 illustrates the three streams under which communication will occur within the Sarbox system (2). Every person who accesses www.SarboxReporter.com (2) will be automatically redirected to the secure Home Page (10). The first step performed by the Security Management Layer (26) is the automatic conversion of the user's access from a non-secure connection (typically http) to a secure connection (e.g. https). The automatic conversion is key to ensuring that nothing is communicated over the internet without it being encrypted. The secure connection currently used by the SarboxReporter (2) is the Secure Sockets Layer protocol, which is currently a standard within the internet community. However, the system is not limited to using this protocol. As security protocols improve the system is structured to be easily converted to even more secure internet communication protocols.

From the Home Page (10) there are three major links that the user can choose. Each link relates to one specific stream or workflow.

The first stream is one to allow individuals to file complaints. This stream is illustrated through items “Input a new Complaint” (11) through the “Confirmation Page” (15) or (16). When the user clicks on the “Input a new Complaint” link (11) they are forwarded to a Company Search Screen (12). This screen contains a list of all of the valid names contained within the system. The user inputs a portion of the company Name provided by the Audit Committee. The system then provides the user with a list of all of the company names that match what the user input. This name matching is another part of the Security Management Layer (26). To ensure that the complaint is directed to the correct company part of the process in assigning new names within the Sarbox system (2) is a review of existing names. At no time will two company names ever exist that may cause a user (1) to not know specifically what company they are filing a complaint under.

Once the key individual (1) selects the proper company name they are then forwarded to a Company Login Screen (13). At this point the user must type in the Company Wide Password. An additional check within the Security Management Layer (26) is the use of the Company Wide Password which is provided by the Audit Committee (3) of the company. By matching both the Company Name within the Company Search Screen (12) and the Company Wide Password within the Company Login Screen (13) the user (1) is ensured that they have properly identified the company under which they are about to file a complaint.

When a key individual (1) accesses the system to file a complaint their communication is intended to be made outside of the company's internal network (5). The reason for this is that it is virtually impossible to guarantee the anonymity of a user if they file a complaint from within a corporate network as “hits” to websites as well as the time in which they were accessed are standard network auditing practices within most companies. As such, for any system and method to meet the requirements of the Sarbanes-Oxley Act it must ensure that a user only accesses the system outside of the company's internal network. The Sarbox system is by design an external application that provides such security checks to ensure that users who are about to file a complaint only access the application from outside of the company's internal network—this is just another component of the Security Management Layer (26). The system compares the IP address of the user's access terminal with a known list of IP addresses used by the company under which the user is filing a complaint. If there is a match the user is immediately notified that their anonymity could be compromised if they try to file a complaint from within the company's network.

Another feature of the Security Management Layer (26) is the prevention of “Hacking”—the act of using computers and computer programs to gain access to another computer or computer system illegally. One feature of this security process is to lock any ID for which a password has been input incorrectly more than the allowable times permitted by the system. Any time this occurs a real time message is sent to the administrators of the Sarbox system (2). The reason for which is to enable the administrators to identify and prevent subsequent attacks to the Sarbox system (2).

Once the user (1) has input the proper Company Wide Password they are then directed to the Complaint Input Screen (14). This screen provides the complainant to type in their complaint in as much detail as necessary, they are provided the name and PO BOX of the Sarbox system administrator (2) in case hardcopy documents are to be submitted. In addition, the user is provided with a checkbox which asks the individual whether or not they are willing to check the site in the future to address any questions the Audit Committee may have regarding their complaint.

Upon submission of their complaint, if the user chooses to check the site in the future to address additional questions of the Audit Committee, they are provided a confirmation screen (15) that provides: the Company Name under which the complaint was filed; the Complaint Number that is systemically generated; a Complaint Password that only they will know and a copy of their complaint.

Another feature of the Security Management Layer (26) is the means by which the complaint password is generated. The password is a random id comprising of upper and lower case letters, symbols and numbers. For security reasons it is assigned and provided to the user only once.

If the user chooses not to check the site in the future to address additional questions of the Audit Committee, they are provided a confirmation screen (16) that provides: the Company Name under which the complaint was filed and a copy of their complaint.

After filing a complaint the user (1) is given a choice to return to the Home Page (10) or exit the system.

Once the complaint has been submitted the Security Management Layer (26) is responsible for ensuring that the complaint is communicated to the assigned managers of the Company (3) and/or (4) depending the Audit Committee—stored in an unalterable state and backed-up to another database location to ensure that at no point are complaints lost. The means by which the complaint is communicated originally to the designated individuals of the Company is by email. However, for security reasons only a notification of the fact that a complaint has been filed is emailed to an Audit Committee member, no information on the complaint is communicated via email as this is an inherently insecure method of communication.

The second stream is one to allow individuals (1) to respond to questions posed by the Audit Committee (3) regarding their complaint. This stream or workflow is illustrated in items “Access Existing Complaint” (17) through to “Complaint Update” (20). When the user (1) clicks on the “Access Existing Complaint” link (17) they are forwarded to a Company Search Screen (18). This screen has the exact same functionality and Security Manager processes (26) as the Company Search Screen (12) described in the first stream. Once the user selects the correct Company Name they are directed to a Complaint Login Screen (19). At this screen only two items are required to be input: the Complaint Number and the Complaint Password which was provided when the complaint was originally filed. Once again the same Security Management Layer (26) controls ensure that no-one hacks the password of any individual complaint.

Once the complainant (1) logs into the complaint they are provided an unalterable history of events related to their complaint within the Complaint Update Screen (20). These events reflect either Audit Committee (3) ( or assigned and approved managers (4)) questions or past comments input by the complainant (1). The user then has the option to add a new entry to the complaint or to exit the system. In the event that the user opts to add an additional entry, either to clarify a previous statement or to respond to a query of the Audit Committee member or delegate—they will receive confirmation that their entry was submitted and recorded by seeing the Complaint Update Screen (20) updated with their new entry in the unalterable history portion of the screen. At that point they will have the option to return to the Home Page (10) or exit the system.

Immediately upon submission the Audit Committee (3) will be notified that an update has been posted to the system.

The third stream is one to allow the Audit Committee (3) and their assigned managers (4) to review, address and track the resolution to filed complaints. This stream is illustrated through items “Company Login” (21) through the “Custom Reports” (25). When the Audit Committee member (3) or Approved Manager (4) clicks on the “Company Login” link (21) they are forwarded to a Company Login Screen (22). This screen contains input boxes for the Company Name, Company Private Password, User Id and the User Password. As part of the Security Management Layer (26) these passwords have the same hack-proof controls to ensure company confidentiality.

An additional reason for this level of granular login is to provide the Company with maximum flexibility to modify user access (i.e. read only access). Again at every level the Sarbox system was built to be flexible enough to meet the requirements of Companies trying to effectively manage their regulatory complaint management requirements.

Once logged into the system the user (3)/(4) will be provided with an Executive Summary of the Complaints (23). This view only provides the Complaint Number, the Date in which the complaint was originally filed, the status—the Audit Committee (3) determines these when the account is established—and the Executive Summary which is intended to summarize the issue and the resolution. Part of the configuration of the system allows the Audit Committee (3) to limit the view to only those complaints that are still outstanding.

The user then has the option to select any complaint number to obtain an Executive Complaint View (24). This page provide the manager with the Company Name, Complaint Number, Status (that can now be updated), the Start Date, the End Date (automatically set when the status is set to CLOSED), a Feedback indicator indicates that the complainant is willing to provide subsequent feedback if necessary (See the details on the first stream above), The Executive Summary Input Sections where the Executive Summary can be updated, an unalterable history of all entries posted within the complaint complete with the date of each entry and the user who posted the entry (i.e. “Complainant” or the User ID of the Manager (3)/(4)) and lastly a new Entry Comment box where a new entry can be added.

Upon submission of a new entry the screen is update to reflect the new entry within the unalterable history section of the Executive Complaint View Page (24) as confirmation that the update was posted.

Upon each update the Security Management Layer (26) ensures that the data is stored and backed-up to prevent the loss of any data.

The user then has the option to view other complaints, update the existing complaint, return to the home page (10) or exit the application.

The creation of Custom Reports (25) is an additional service that is made to the users (3)/(4) of the Sarbox system (2). This is meant to be a completely customizable open request forum where a Company who had subscribed to the service specifies the form of reports and means by which they will be transmitted. The structure of the Sarbox System (2) lends itself to easily creating a multitude of reports. So this process was created to provide Companies with the flexibility to specify how they prefer their information to be summarized. Additional services offered as part of the Sarbox system (2) are Special Investigators (7) who could serve as an independent consultant to investigate matters the Audit Committee (3) would not want to assign to an internal manager (4).

The Security Management Layer (26) is a key component to achieving the security required to meet the precise requirements of the ACT. As such, it is intended to be augmented as new security measures are available and actively managed by the Sarbox system administrator (2).

These three streams combined with the Security Management Layer fully address the requirements of the Sarbanes Oxley Act Section 301 requirements which stipulate: Each company shall establish procedures for (A) the receipt, retention and treatment of complaints received by the issuer regarding accounting, internal accounting controls, or auditing matters; and (B) the confidential, anonymous submission by employees of the issuer of concerns regarding questionable accounting or auditing matters.

Receipt is ensured through the first stream Security Management Layer (26) Company Name and Login checks. Retention is ensured through the independent database storage and back-up of all entries via the Security Management Layer (26) employed in all three streams. Treatment of complaints is captured within the individual managerial responses within the Executive Complaint View Screen (24) and summarized within the Executive Summary (23). Confidentiality is achieved through all of the Security Management Layer (26) processes performed within the independent Sarbox system (2).

1) a method of providing sarbanes-oxley anonymous reporting for a public company, said method comprising:
i) receiving in an independent secure database information pertaining to an event relating to accounting practices, internal accounting controls, and/or auditing of said public company,
ii) accessing said database via a network interface to enable anonymous submission of information by a user regarding said event (e.g. filing a complaint),
iii) providing an audit committee with secure restricted access to certain information of said database to obtain read-only information about said event and to input status and results of an investigation pertaining to said event, and
iv) providing said user with secondary access to said database to enable tracking of status information about an earlier reported event supplied by said audit committee and/or to anonymously submit additional information relative to said event.

2) The method as recited in claim 1, wherein said accessing step comprises accessing said database via an Internet.

3) The method as recited in claim 1, wherein said public company has the ability to restrict access to file an event (i.e. complaint) to key individuals—all individuals who are in a position to know material facts about the accounting, internal accounting controls or auditing matters of an organization.

4) The method as recited in claim 2, further comprising an automated securing of the communication to ensure that user can only communicate via a secure channel over the Internet.

5) The method as recited in claim 2, wherein said accessing step comprises querying said user regarding independence of said access network in order to further assure anonymity vis-à-vis said a corporate network

6) The method as recited in claim 5, wherein said accessing step further comprises confirming independence of said access network by comparing an IP address of a network address terminal with a stored list of IP address applicable to the company under which said event is reported.

7) The method as recited in claim 1, further comprising the step of notifying an audit committee of receipt of said event by said database

8) The method as recited in claim 1, further comprising the step of confirming to said user that their complaint has been filed.

9) The method as recited in claim 1, further comprising the step of matching both a Company Name and Password prior to said user posting a complaint as a further security measure and a means to guarantee delivery of complaint to the respective audit committee.

10) The method as recited in claim 1, further comprising the step of creating a back-up of the new complaint entry into the database to prevent any data loss and guarantee delivery of entry to the audit committee.

11) The method as recited in claim 10 wherein said notifying occurs via email

12) The method as recited in claim 1, further comprising assigning a high-level encrypted password to said user to enable further access to said database, said password comprising a combination of alpha characters, numeric characters, upper case characters and lower case characters.

13) The method as recited in claim 12, further comprising automatically locking out a user for a fixed time period after attempting to gain access to said database with an incorrect password

14) The method of claim 13, wherein said automatic lock-out occurs after ten attempts

15) The method of claim 14, wherein said fixed time period is at least one-half hour.

16) A system that provides Sarbanes-Oxley anonymous reporting for a public company, said system comprising:
i) An independently escrowed, secure database to receive information pertaining to an event relating to accounting practices, internal accounting controls, and auditing of said public company,
ii) A user interface of said database accessible by a user to enable anonymous submission of information regarding said event,
iii) An audit interface that provides an audit committee with secure, restricted access to certain information of said database to obtain read-only information about said event and to input status and results of an investigation pertaining to said event, and
iv) An audit interface that allows said user to request information from original complainant.
v) Said user interface providing said user with secondary anonymous access to said database to track status information supplied by said audit committee about an earlier reported event and/or to anonymously submit additional information about said event.

17) The system as recited in claim 16, further comprising an email agent that sends notification of receipt of said event by said database to an audit committee after receipt thereof.

18) The method as recited in claim 16, wherein said accessing step comprises accessing said database via an Internet.

19) The method as recited in claim 16, further comprising an automated securing of the communication to ensure that user can only communicate via a secure channel over the

20) The method as recited in claim 16, further comprising assigning a high-level encrypted password to said user to enable further access to said database, said password comprising, as determined by the Audit Committee, a combination of alpha characters, numeric characters, upper case characters and lower case characters.

21) The method as recited in claim 16, further comprising automatically locking out a user for a fixed time period after attempting to gain access to said database with an incorrect password

22) The method of claim 21, wherein said automatic lock-out occurs after ten attempts

23) The method of claim 22, wherein said fixed time period is at least one-half hour.

24) The method as recited in claim 16, further comprising the step of confirming to said user that their management entry has been recorded.

25) The method as recited in claim 24, further comprising the step of creating a back-up of the new management entry into the database to prevent any data loss and guarantee delivery of entry to the audit committee.

26) The method of combining all events related to the original complaint filed via method as recited in claim 1 and 16 into a single management view.
